(19) United States
(12) Patent Application Publication
(10) Pub. No.: US 2015/0046480 A1
(43) Pub. Date: Feb. 12, 2015

(54) INFORMATION PROCESSING DEVICE FOR EXECUTING LOAD EVALUATION, AND LOAD EVALUATION METHOD

(71) Applicant: NEC Corporation, Minato-ku, Tokyo (JP)

(72) Inventor: Yasuhiro Ajiro, Tokyo (JP)

(73) Assignee: NEC Corporation, Minato-ku, Tokyo (JP)

(21) Appl. No.: 14/387,030

(22) PCT Filed: Mar. 18, 2013
(86) PCT No.: PCT/JP2013/001830

§ 371 Date: Sep. 22, 2014

(30) Foreign Application Priority Data
Mar. 30, 2012 (EP) 2012-079419

(51) Int. Cl. G06F 17/30; H04L 29/08

(52) U.S. Cl. CPC G06F 17/30424; H04L 67/10
USPC 707/754; 707/736

(57) ABSTRACT

The present invention provides an information processing device that is capable of evaluating whether a desired load is being generated for application to a test-target system. The information processing device includes: a means that calculates the request rates per unit time on the basis of time series data for requests sent from a load generation device, aggregates the request rates on the basis of predetermined class data, and creates frequency distribution data; a means that acquires expected frequency distribution data, which is frequency distribution data expected when it is assumed that the distribution of request rates follows a desired probability distribution; and a means that carries out goodness-of-fit testing of the observed frequency distribution data with the probability distribution by using the created observed frequency distribution data and the acquired expected frequency distribution data.

### REFERENCE TO RELATED APPLICATION

This application is a National Stage Entry of PCT/JP2013/001830 filed Mar. 18, 2013, which is based on and claims the benefit of the priority of Japanese Patent Application No. 2012-079419, filed on Mar. 30, 2012, the disclosure of all of which are incorporated herein in their entirety by reference.

### TECHNICAL FIELD

The present invention relates to load testing for a system, a server, or the like, and relates to a technique for evaluating whether a desired load is being generated for a target for testing.

### BACKGROUND ART

Load testing is known as one of the methods for checking behavior of a system, a server, or the like under application of a high load. In load testing, a pseudo load is applied to a system, a server, or the like that is a target.

Load testing is often carried out by a load testing device using software called load testing tools. A load testing device applies a load to a test-target system by transmitting requests to the test-target system. The test-target system processes each request received from the load testing device, and then responds to the load testing device.

An example of such a test-target system is a server hosting an online shopping site. In the following, description will be given of a load applied to a server hosting an online shopping site when the site is in real use.

An unspecified number of customers use an online shopping site. When customers visit an online shopping site, the individual customers repeatedly transmit requests and receive responses to the respective request. Examples of a request that a customer transmits to the server of the site are requests to browse a product, select a product, check a shopping cart, input a delivery address or a credit card number, and the like. Then, the customer receives a response (e.g., description of a product, an image of a product, a video of a product, or the like) to each request transmitted by the customer. Thereafter, the customer, for example, checks the displayed page of the product or considers which product to choose, and then transmits a next request.

When the customer has achieved an aim, e.g., to buy a desired product, after repeating a series of request transmissions and response receptions, the customer finishes browsing the online shopping site.

It is known that, in a system that receives requests from an unspecified number of customers such as an online shopping site, the intervals between request arrivals from the customers follow an exponential distribution. Here, the interval between arrivals corresponds to the time interval from the arrival of a request to the arrival of the next request. It is also known that, when the intervals between request arrivals follow an exponential distribution, the request arrival rates (each corresponding to the number of request arrivals per unit time) follow a Poisson distribution.

Patent Literature 1 discloses an example of a load testing device. According to the load testing device disclosed in Patent Literature 1, an operator of the load testing device inputs the ‘number of requests to be processed per unit time’ that should be achieved by a test-target system, as a performance target for load testing. The load testing device transmits requests by automatically adjusting various kinds of parameters for the load testing so as to achieve the performance target inputted by the operator.

Patent Literature 2 discloses a method of determining a load capacity of a server. The method disclosed in Patent Literature 2 includes the following steps. In the first step of the method, behaviors of one or more virtual users are simulated, and one or more client requests are transmitted to a server. In the second step of the method, the metric indicating a performance index of the server is measured. In the third step of the method, the measured metric is compared with a predetermined value, and the number of virtual users is changed on the basis of the difference between the metric and the predetermined value until the metric falls within a predetermined range of the predetermined value.

Patent Literature 3 discloses a distribution goodness-of-fit testing device. The distribution goodness-of-fit testing device disclosed in Patent Literature 3 includes a counting section determining means, a counting means, and a goodness-of-fit testing means. The counting section determining means determines the widths of counting sections for counting pieces of measured data so that the expected frequencies would have equal probabilities. The counting means counts the number of pieces of data in each determined section. The goodness-of-fit testing means tests a goodness-of-fit test of the counted pieces of data with the probability distribution.

Patent Literature 4 discloses a technique for detecting an anomaly in an operation state by using a chi-square test.

Patent Literature 5 discloses a technique for generating a frequency distribution.

### CITATION LIST

### Patent Literature

PTL 1: Japanese Patent Application Publication No. 2006-31178
PTL 2: Japanese Patent Application Publication No. 2010-244528
PTL 3: Japanese Patent Publication No. 4349216
PTL 4: Japanese Patent Application Publication No. 2011-034208
PTL 5: Japanese Patent Application Publication No. 2010-257227

### SUMMARY OF INVENTION

### Technical Problem

It is not possible to rely on any results obtained from load testing that does not accurately simulate load to be applied in real use. Hence, load testing devices are required to accurately simulate load to be applied to a test-target system in real use.

To accurately simulate load to be applied to the test-target system in real use, a load testing device needs to transmit requests while satisfying at least the following two requirements. The first requirement is that the average number of requests transmitted per unit time corresponds to a desired value. The second requirement is that requests are transmitted at time intervals following a predetermined distribution (in other words, the number of requests transmitted per unit time follows a predetermined distribution).

The load testing device according to Patent Literature 1 evaluates whether or not the requests transmitted by the load testing device satisfy the first requirement. However, the load testing device does not evaluate whether the second requirement is satisfied.

It is important for reliability of results of load testing whether or not the requests transmitted by the load testing device satisfy the second requirement. This is because response times are different between a case of having regular time intervals between request arrivals and a case of having irregular time intervals, even when the request processing performance and the average number of request arrivals of the test-target system are each the same in the two cases. Here, a response time corresponds to a time period needed from arrival of a request at the test-target system to reception of a corresponding response at the load testing device.

In general, in a case of having irregular time intervals between request arrivals, each response time tends to be longer than that in a case of having regular time intervals between request arrivals. This is because, when a situation in which requests are transmitted at short intervals is continued in a case of having irregular intervals between request arrivals, a great number of requests arrive at the test-target system, which consequently causes a queue.

To avoid underestimation of time periods required to respond to requests, a load testing device needs to transmit requests at time intervals following a predetermined distribution instead of at regular time intervals. However, no device that evaluates whether or not requests transmitted by a load testing device satisfy a predetermined distribution has been known.

The invention of the present application has an object to provide an information processing device, a load evaluation method, and a program that are for carrying out load evaluation for evaluating whether a load testing device is generating a desired load for application to a test-target system.

### Solution to Problem

A first invention to solve the above-described problem is an information processing device including: a time series data storing means for storing time series data including a transmission time point of each request transmitted from a load generation device to a test-target system; an observed frequency distribution creating means for calculating a request rate, which is the number of requests transmitted per unit time, by using the time series data, aggregating the request rates with reference to class data, which indicates aggregation section widths for creating frequency distribution data, and creating frequency distribution data of the request rates; an expected frequency distribution acquiring means for acquiring expected frequency distribution data, which is frequency distribution data expected when it is assumed that the distribution of the request rates follows a desired probability distribution; and a goodness-of-fit testing means for carrying out goodness-of-fit testing of the observed frequency distribution data with the desired probability distribution by using the observed frequency distribution data and the expected frequency distribution data.

A second invention to solve the above-described problem is an information processing device including: a time series data storing means for storing time series data including a transmission time point of each request transmitted from a load generation device to a test-target system; an observed frequency distribution creating means for calculating request transmission time intervals by using the time series data, aggregating the request transmission time intervals with reference to class data, which indicates aggregation section widths for creating frequency distribution data, and creating frequency distribution data of the request transmission time intervals; an expected frequency distribution acquiring means for acquiring expected frequency distribution data, which is frequency distribution data expected when it is assumed that a distribution of the request transmission time intervals follows a desired probability distribution; and a goodness-of-fit testing means for carrying out goodness-of-fit testing of the observed frequency distribution data with the desired probability distribution by using the observed frequency distribution data and the expected frequency distribution data.

A third invention to solve the above-described problem is a method of controlling a device including a time series data storing means for storing time series data including a transmission time point of each request transmitted from a load generation device to a test-target system, the method controlling the device to perform: a step of calculating request rates, each of which is the number of requests transmitted per unit time, by using the time series data, aggregating the request rates with reference to class data, which indicates aggregation section widths for creating frequency distribution data, and creating frequency distribution data of the request rates; a step of acquiring expected frequency distribution data, which is frequency distribution data expected when it is assumed that a distribution of the request rates follows a desired probability distribution; and a step of carrying out goodness-of-fit testing of the observed frequency distribution data with the desired probability distribution.

A fourth invention to solve the above-described problem is a non-transitory computer-readable recording medium recording a program for causing a computer including a time series data storing means for storing time series data including a transmission time point of each request transmitted from a load generation device to a test-target system, to execute: an observed frequency distribution creating process for calculating request rates, which is number of requests transmitted per unit time, by using the time series data, aggregating the request rates with reference to class data, which indicates aggregation section widths for creating frequency distribution data, and creating frequency distribution data of the request rates; an expected frequency distribution acquiring process for acquiring expected frequency distribution data, which is frequency distribution data expected when it is assumed that a distribution of the request rates follows a desired probability distribution; and a goodness-of-hit testing process for carrying out goodness-of-fit testing of the observed frequency distribution data with the desired probability distribution.

### Advantageous Effects of Invention

It is possible to provide an information processing device, a load evaluation method, and a program that are for carrying out load evaluation for evaluating whether a load testing device is generating a desired load for application to a test-target system. Here, ‘whether a load testing device is generating a desired load for application to a test-target system’ includes ‘whether requests transmitted by a load testing device follow a predetermined distribution’.

### BRIEF DESCRIPTION OF DRAWINGS

FIG. 1 is a network configuration diagram including a load evaluation device 1 according to the first exemplary embodiment.

FIG. 2 is a block diagram illustrating the configuration of the load evaluation device 1 according to the first exemplary embodiment.

FIG. 3 is an example of time series data stored in a time series data storing unit 111.

FIG. 4 is an example of data stored by a chi-square distribution data storing unit 112.

FIG. 5 is an example of class data acquired by a class acquiring unit 122.

FIG. 6 is an example of observed frequency distribution data of request rates.

FIG. 7 is an example of expected frequency distribution data.

FIG. 8 is a flowchart illustrating the operation of the load evaluation device 1 according to the first exemplary embodiment.

FIG. 9 is an example of observed frequencies and expected frequencies that are combined.

FIG. 10 is an example of observed frequency distribution data of request rates.

FIG. 11 is a block diagram illustrating the configuration of a load testing device 2 according to a second exemplary embodiment.

FIG. 12 is a flowchart illustrating typical behavior of a virtual user in a closed model.

FIG. 13 is a flowchart illustrating typical behavior of a virtual user in an open model.

FIG. 14 is a block diagram illustrating the configuration of a load evaluation device 1 according to the second exemplary embodiment.

FIG. 15 is a flowchart illustrating the operation of the load evaluation device 1 according to the second exemplary embodiment.

FIG. 16 is a block diagram illustrating the configuration of a load evaluation device 1 according to a third exemplary embodiment.

FIG. 17 is an example of a probability density function of an exponential distribution.

FIG. 18 is an example of a probability mass function of a Poisson distribution.

FIG. 19 is a block diagram illustrating the configuration of a load evaluation device 1 according to a fourth exemplary embodiment.

FIG. 20 is a diagram illustrating the hardware configuration of a computer 700 for implementing the load evaluation device 1 according to the first exemplary embodiment.

### DESCRIPTION OF EMBODIMENTS

### First Exemplary Embodiment

### <Description of Configuration>

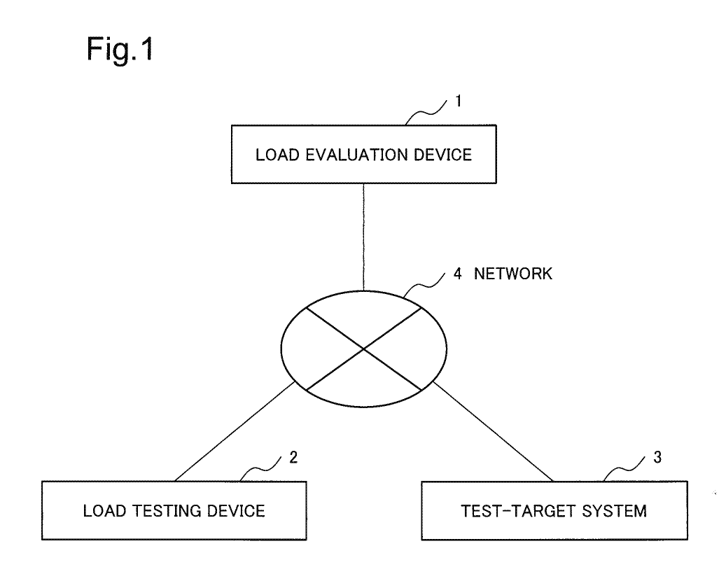

FIG. 1 is a network configuration diagram including a load evaluation device (also called an information processing device) 1 according to the first exemplary embodiment.

The load evaluation device 1 is connected to each of a load testing device 2 and a test-target system 3 via a network 4 to be able to communicate with each other.

The load testing device 2 (also called a load generation device) is a device for carrying out load testing for the test-target system 3. The load testing device 2 establishes a TCP (Transmission Control Protocol) connection with the test-target system 3, and applies a load to the test-target system 3 by continuously transmitting requests to the test-target system 3.

The test-target system 3 is a server, a system, or the like that is a target for load testing. The test-target system 3 processes each request received from the load testing device 2, and then responds to the load testing device 2.

While the test-target system 3 is successfully processing all arrived requests, each time interval between request transmissions by the load testing device 2 is equal to the time interval between corresponding request arrivals when seen from the test-target system 3. Moreover, while the test-target system 3 is successfully processing all arrived requests, each request transmission rate is equal to the request arrival rate when seen from the test-target system 3. Here, the request transmission rate corresponds to the average number of request transmissions by the load testing device 2 per unit time. The request arrival rate corresponds to the average number of request arrivals per unit time when seen from the test-target system 3.

In the following, a request transmission interval and a request arrival interval will be referred to as a request interval collectively. In addition, a request transmission rate and a request arrival rate will be referred to as a request rate collectively. The value of a request transmission rate and the value of a request arrival rate are the same as the throughput value indicating the number of requests to be processed per unit time.

The load evaluation device 1 acquires a log of data on communications between the load testing device 2 and the test-target system 3. Then, the load evaluation device 1 calculates the request intervals or the request rates by using the acquired log. The load evaluation device 1 evaluates whether or not the distribution of the request intervals or the request rates thus calculated fits the probability distribution desired by the operator of the load testing device 2.

In this exemplary embodiment, a system that receives requests from an unspecified number of customers, e.g., an online shopping site, is assumed as the test-target system 3. It is known that, when such a system is in real use, request intervals correspond to random numbers following a probability distribution such as an exponential distribution or a Pareto distribution.

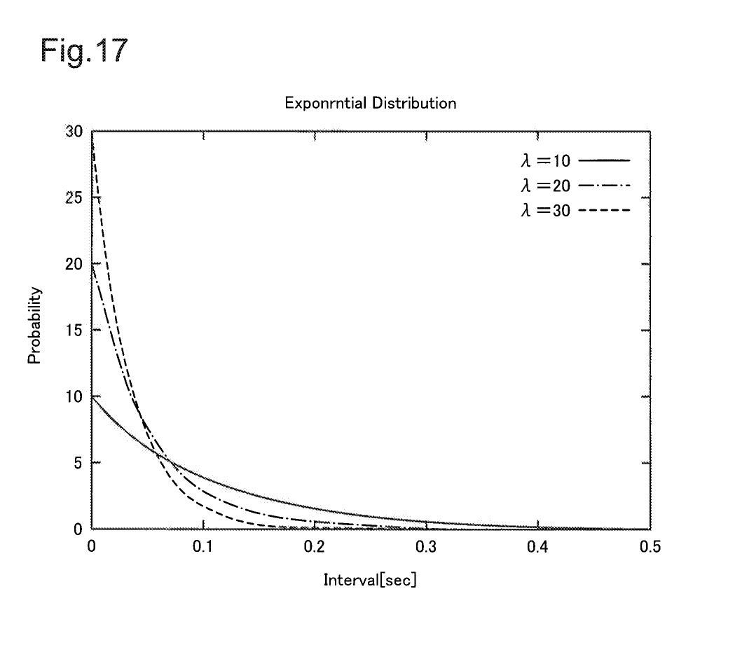

An example of a probability density function of an exponential distribution is presented in FIG. 17. In FIG. 17, the horizontal axis represents the length of a request interval, and the vertical axis represents a probability. The exponential distribution is a probability distribution with a parameter λ, and an expected value (average value) is represented by 1/λ. When a request interval is 1/λ, the inverse number λ represents the number of requests per second (the request rate).

For example, when the average request interval is 1/20 (=0.05) second, the average request rate is 20 [requests/second]. It is known that, when the request intervals follow an exponential distribution, the request rates follow a Poisson distribution.

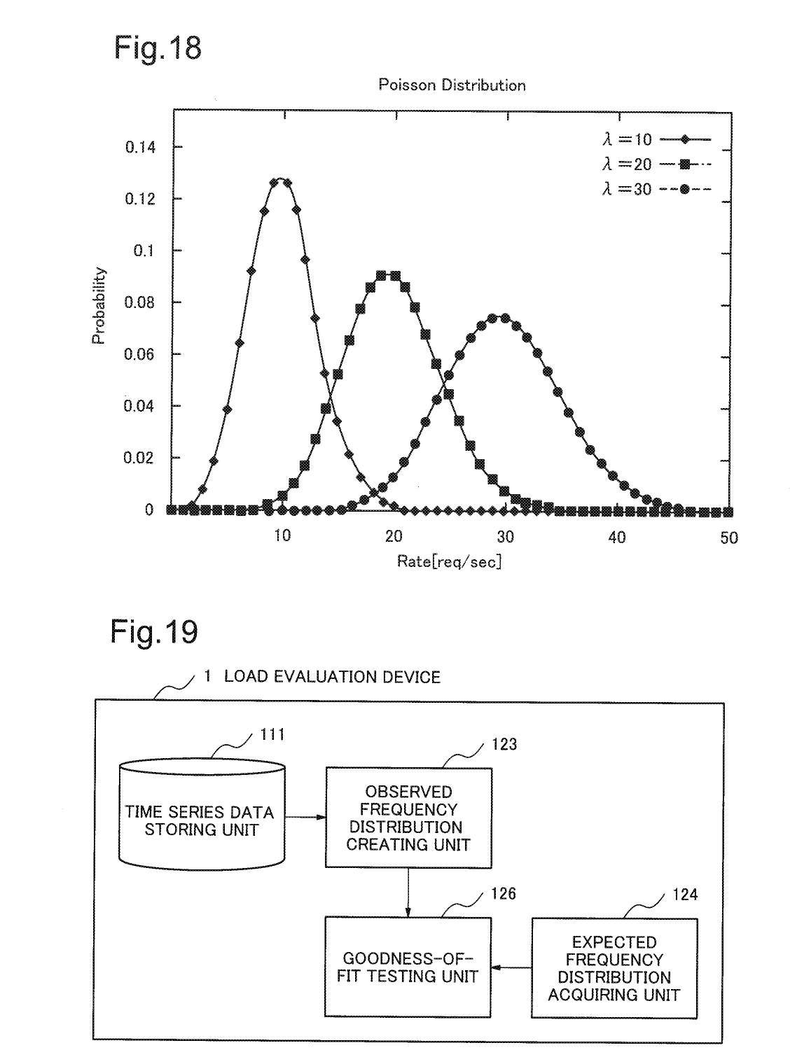

An example of a probability mass function of a Poisson distribution is presented in FIG. 18. In FIG. 18, the horizontal axis represents a request rate, and the vertical axis represents a probability. A probability mass function is a probability density function of a discrete probability distribution. Since request rates can only be integers, the probability distribution of request rates is represented as a probability mass function.

When the request intervals or the request rates are not constant (a fixed number) but follow the probability distribution as presented in FIG. 17 or FIG. 18, request arrival intervals are sometimes short and sometimes long, or the numbers of requests arriving per unit time are sometimes large and sometimes small. When a large number of requests are arriving at the test-target system 3, a queue occurs, which consequently increases the possibility of extending response times.

In general, response times are longer in a case of having variable request intervals such as the cases in FIG. 17 and FIG. 18, than those in a case of having regular request intervals, even when the average lengths of request intervals are the same in both cases.

As described above, it is empirically known that request intervals and request rates are variable when the test-target system 3 is in real use. Hence, to accurately simulate load applied to the test-target system 3 in real use, it is reasonable to set the request intervals for request transmissions by the load testing device 2 so as to simulate load variations, by using a probability distribution or the like.

On the other hand, if the request intervals for transmitting requests by the load testing device 2 do not match those intended by the operator, the value of throughput and the value of each response time obtained as a result of load testing are not reliable. Accordingly, in order to ensure the reliability of the results of load testing, it is necessary to evaluate whether the request intervals follow the distribution intended by the operator of the load testing device 2.

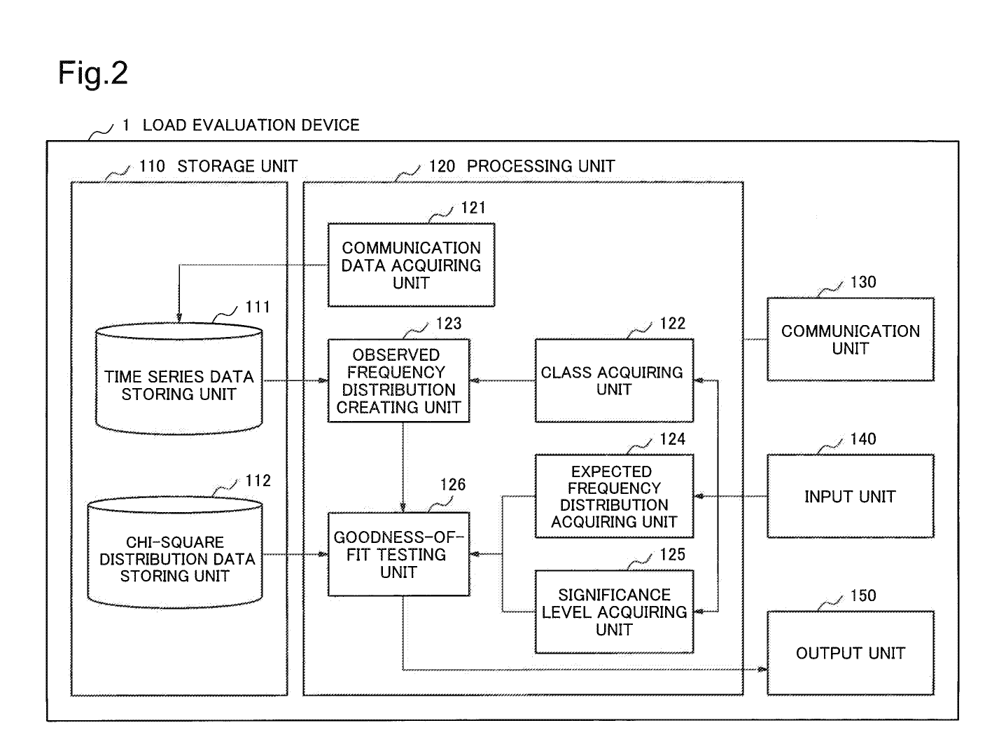

FIG. 2 is a block diagram illustrating the configuration of the load evaluation device 1 according to the first exemplary embodiment of the present invention. The load evaluation device 1 is a computer configured by including a storage unit 110, a processing unit 120, a communication unit 130, an input unit 140, and an output unit 150.

The storage unit 110 is configured by including a time series data storing unit 111 and a chi-square distribution data storing unit 112.

The time series data storing unit 111 stores time series data of communications between the load testing device 2 and the test-target system 3. Time series data includes at least the transmission time point of ‘each request transmitted from the load testing device 2 to the test-target system 3.’ The time series data may include data of TCP connection requests, TCP disconnection requests, and the like from the load testing device 2 to the test-target system 3.

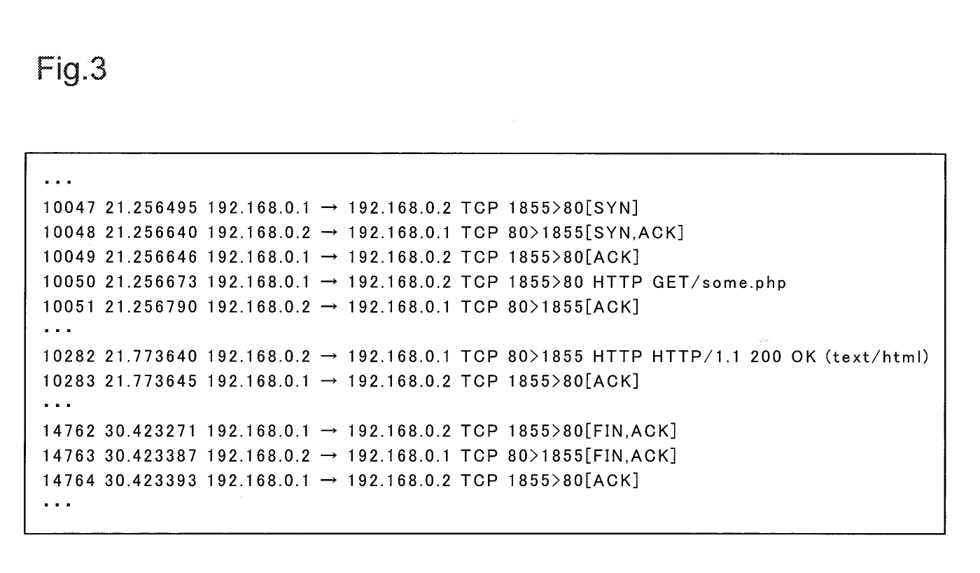

FIG. 3 is a view illustrating an example of data stored by the time series data storing unit 111. The data presented in FIG. 3 represents log information of communications between the load testing device 2 and the test-target system 3.

The leftmost column in FIG. 3 provides row numbers. The second column from the left provides time (seconds) elapsed since the acquisition of the log started. Each of S and D in ‘S->D’ in each row in the third to fifth columns from the left represents the IP (Internet Protocol) address of a host. In addition, ‘S->D’ indicates that data has been transmitted from S to D. The sixth column provides communication protocol. ‘TCP’ in this example indicates that a TCP protocol is used. The tenth column provides the type of TCP packet, and the eleventh and subsequent columns provide the contents transmitted using a HTTP (HyperText Transfer Protocol) protocol.

In the example of the time series data storing unit 111 presented in FIG. 3, the data in the row with the number 10050, for example, indicates that the machine identified with the IP address 192.168.0.1 transmitted a GET request for the contents corresponding to /some.php in the machine identified with the IP address 192.168.0.2 at the time point that is 21.256673 seconds after the acquisition of the log started. As described above, the time series data storing unit 111 stores time series data including time points of request transmissions.

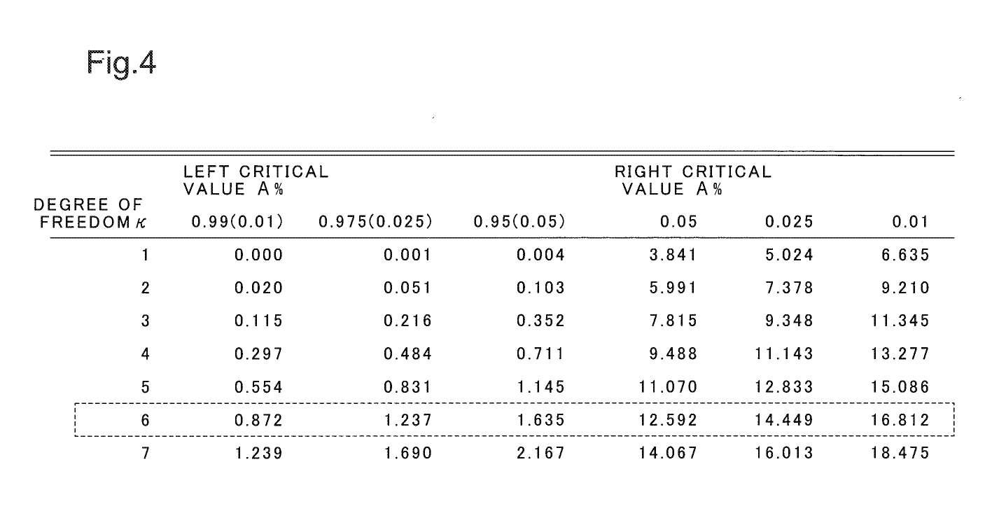

The chi-square distribution data storing unit 112 stores a chi-square distribution table including the values of a chi-square distribution or a calculation formula for calculating chi-square distribution values. Obtained chi-square distribution values are used when a chi-square distribution test to be described later is carried out. FIG. 4 illustrates an example of a chi-square distribution table stored by the chi-square distribution data storing unit 112. The details of the chi-square distribution table will be described later.

The processing unit 120 includes a communication data acquiring unit 121, a class acquiring unit 122, an observed frequency distribution creating unit 123, an expected distribution acquiring unit 124, a superior level acquiring unit 125, and a goodness-of-fit testing unit 126.

The communication data acquiring unit 121 acquires data on communications between the load testing device 2 and the test-target system 3. Then, the communication-data acquiring unit 121 stores the acquired data on the communications into the time series data storing unit 111. Here, concrete examples of the data on the communications are request transmissions, TCP connection requests, and TCP disconnection requests.

The class acquiring unit 122 receives ‘class data’ required to create a ‘frequency distribution’ from the operator of the load evaluation device 1.

The frequency distribution is a distribution of the numbers of pieces of sample data with respect to a certain property or a certain variate. The frequency distribution is also called a frequent distribution. The classes of a property or the ranges of a variate (aggregation section widths) used for classifying the pieces of sample data are called classes.

The class data is data for defining classes. In the load evaluation device 1 according to this exemplary embodiment, a class corresponds to the range of a section for request intervals or request rates of requests transmitted by the load testing device 2.

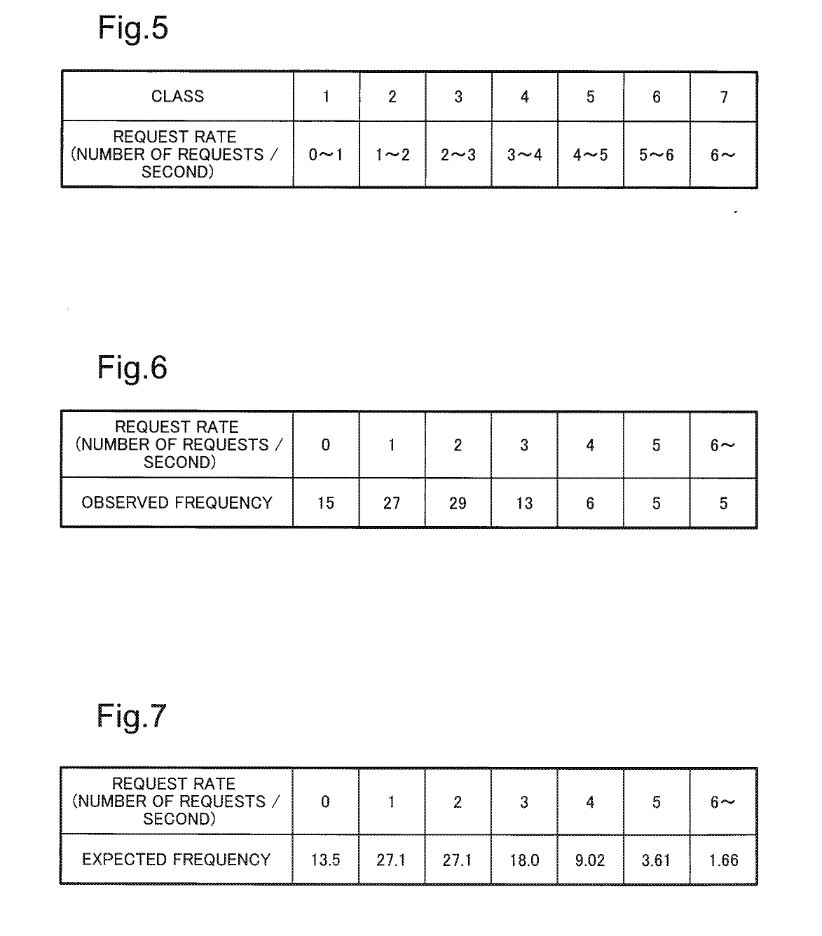

FIG. 5 is a table illustrating an example of the class data acquired by the class acquiring unit 122. The class data presented in FIG. 5 is an example of class data related to the request rates, and the contents of the class data are as follows. In this example, seven classes are defined. Note that ‘6-’ indicates a request rate of ‘6 or higher’.

Class 1: higher than or equal to 0 (requests/second) and lower than 1 (requests/second)

Class 2: higher than or equal to 1 (requests/second) and lower than 2 (requests/second)

Class 3: higher than or equal to 2 (requests/second) and lower than 3 (requests/second)

Class 4: higher than or equal to 3 (requests/second) and lower than 4 (requests/second)

Class 5: higher than or equal to 4 (requests/second) and lower than 5 (requests/second)

Class 6: higher than or equal to 5 (requests/second) and lower than 6 (requests/second)

Class 7: higher than or equal to 6 (requests/second)

The observed frequency distribution creating unit 123 calculates request rates or request intervals on the basis of the time series data stored by the time series data storing unit 111. Then, the observed frequency distribution creating unit 123 aggregates the request rates or the request intervals thus calculated, on the basis of the class data received by the class acquiring unit 122, and thereby creates ‘observed frequency distribution data’.

The observed frequency distribution data is data associating the classes and the frequencies obtained by counting the frequencies corresponding to the respective classes included in the class data.

FIG. 6 is a table illustrating an example of observed frequency distribution data related to request rates, the data created by the observe-frequency distribution creating unit 123. In the observed frequency distribution data presented in FIG. 6, the total of the observed frequencies (the total of pieces of sample data) is 100. The pieces of observed frequency distribution data have been aggregated according to the class data acquired by the class acquiring unit 122.

The expected distribution acquiring unit 124 acquires or calculates ‘expected frequency distribution data’ for testing whether or not the observed frequency distribution fits the distribution intended by the operator.

FIG. 7 is a table illustrating an example of the expected distribution data acquired by the expected distribution acquiring unit 124. The expected distribution is a frequency distribution expected when it is assumed that the distribution of observed values follows a probability distribution desired by the operator. Here, the observed values are values analyzed from the time series data stored by the time series data acquiring unit 111.

When the observed frequency distribution is a frequency distribution related to request rates, the expected distribution is assumed to follow a Poisson distribution. The expected distribution presented in FIG. 7 is a distribution calculated under the condition that the total of the frequencies of the expected distribution is equal to the value of the total of the frequencies of the observed frequency distribution, according to the Poisson distribution with λ (expected value) of 2.

The superior level acquiring unit 125 acquires a significance level value in a chi-square test from the operator. The significance level value is a probability value, e.g., 5% or 1%. The acquired significance level value is used in a chi-square test to be described later.

The goodness-of-fit testing unit 126 carries out a goodness-of-fit test (chi-square test) for the observed frequency distribution data created by the observed frequency distribution creating unit 123 and the expected distribution data acquired by the expected frequency distribution acquiring unit 124. In this way, the goodness-of-fit testing unit 126 evaluates whether or not the request rates or the request transmission intervals of the requests transmitted by the load testing device 2 follow the distribution desired by the operator of the load testing device 2.

The communication unit 300 communicates with the load testing device 2 and the test-target system 3.

The input unit 400 receives inputs from the operator of the load evaluation device 1.

The output unit 500 outputs information to the operator of the load evaluation device 1.

### <Hardware Configuration>

The storage unit 110 of the load evaluation device 1 may be implemented by using a RAM (Random Access Memory), a HDD (Hard Disk Drive), or the like. Each means included in the processing unit 120 may be implemented in such a way that a CPU (Central Processing Unit) included in the load evaluation device 1 executes a predetermined program or predetermined codes. The communication unit 130 may be implemented in such a way that an application program controls a network interface card (NIC: Network Interface Card) by using a function provided by an OS (Operating System), for example. The input unit 140 may be implemented by using a keyboard and a mouse, for example. The output unit 150 may be implemented by using a display, for example.

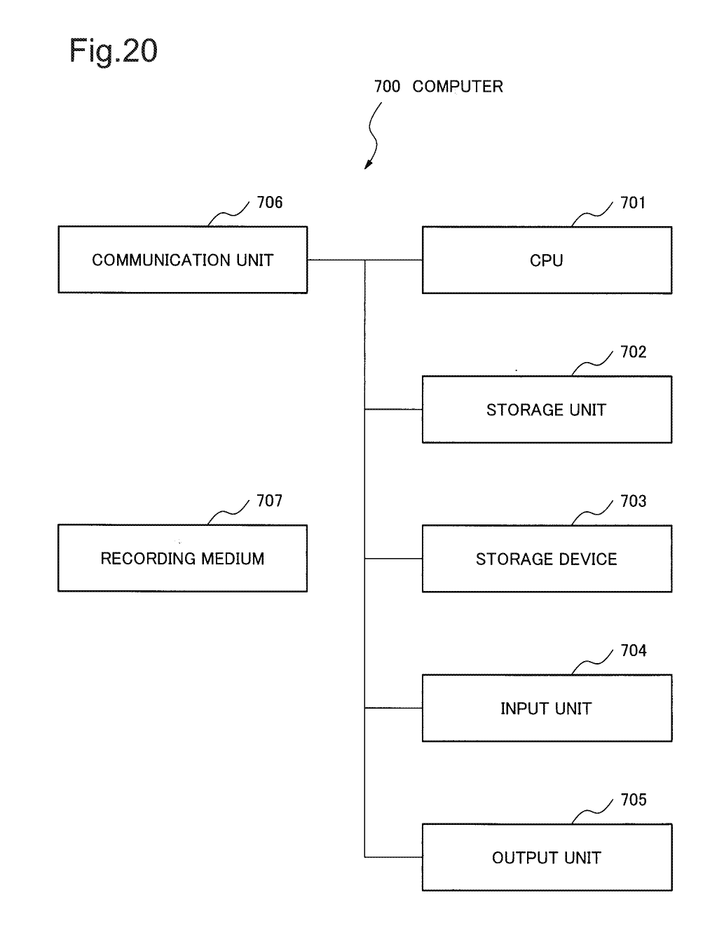

FIG. 20 is a diagram illustrating a hardware configuration of a computer 700 for implementing the load evaluation device 1 according to this exemplary embodiment.

As illustrated in FIG. 20, the computer 700 includes a CPU (Central Processing Unit) 701, a storage unit 702, a storage device 703, an input unit 704, an output unit 705, and a communication unit 706. In addition, the computer 700 includes a recording medium (or a storage medium) 707 provided externally. The recording medium 707 may be a nonvolatile recording medium, which is non-transitory and retains information regardless of power supply.

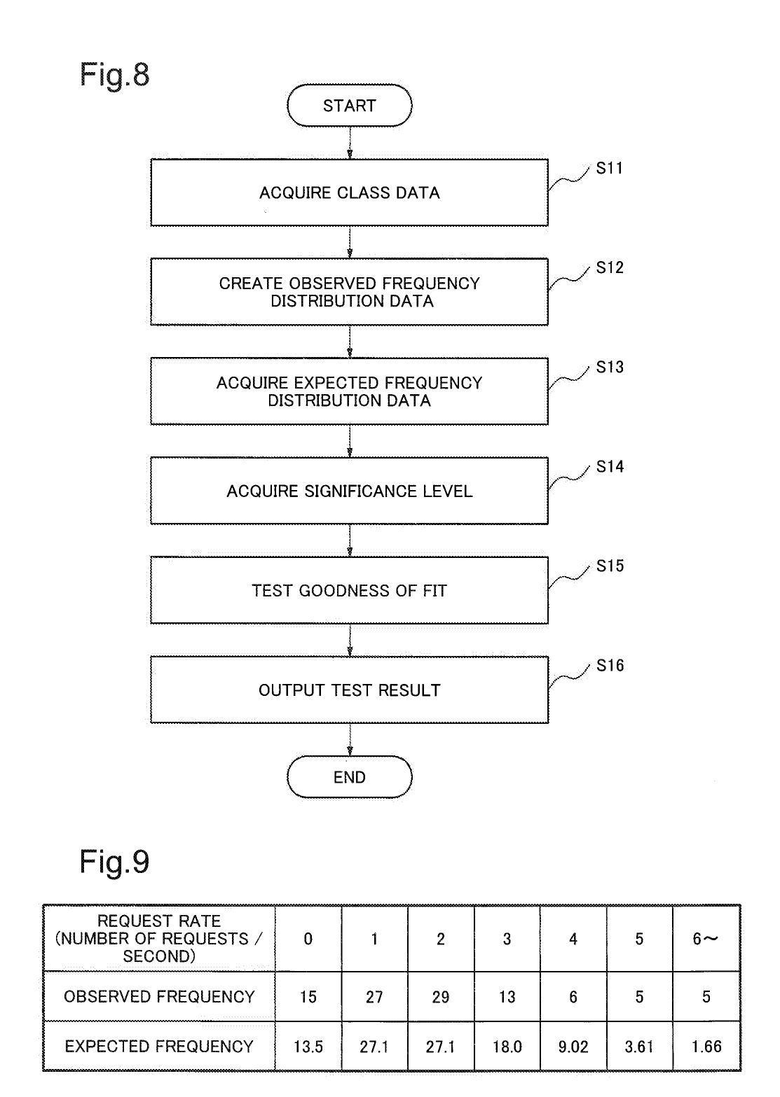

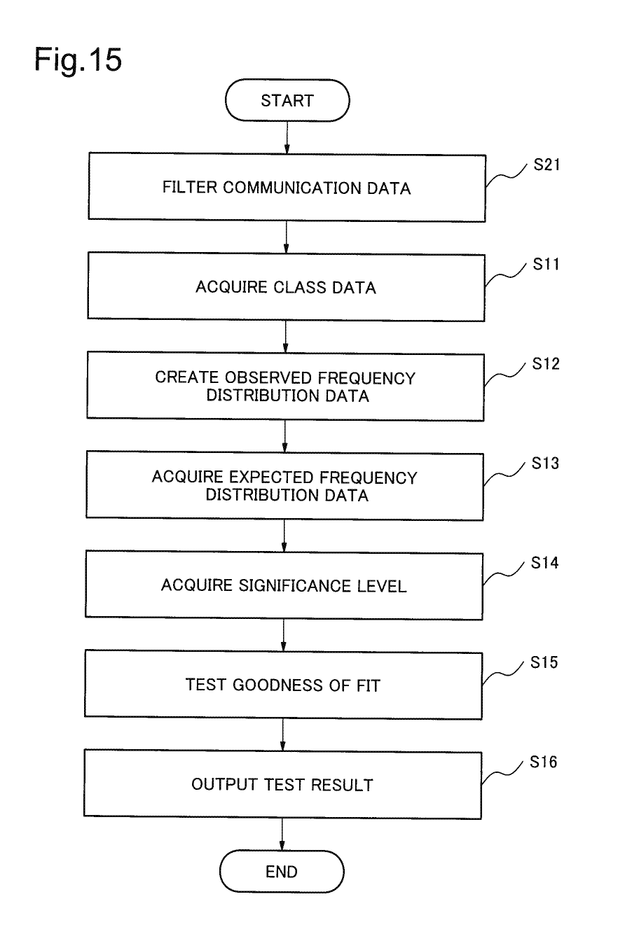

The CPU 701 controls the entire operation of the computer 700 by causing the operating system (not illustrated) to operate. In addition, the CPU 701 loads a program or data from the recording medium 707 supplied to the storage device 703, for example, and writes the loaded program or data in the storage unit 702. Here, the program is, for example, a program for causing the computer 700 to perform the operations in the flowcharts presented in FIG. 8 and FIG. 15 to be described later.

Then, the CPU 701 carries out various processes as the processing unit 120 presented in FIG. 2, according to the loaded program or on the basis of the loaded data.

Alternatively, the CPU 701 may be configured to download a program or data from an external computer (not illustrated) connected to a communication network (not illustrated), to the storage unit 702.

The storage unit 702 may correspond to the storage unit 120 in FIG. 2.

The storage device 703 is, for example, an optical disk, a flexible disk, a magneto-optical disk, an external hard disk, or a semiconductor memory, and includes the recording medium 707. The storage device 703 (recording medium 707) stores programs in a computer-readable manner. The storage device 703 may store data. The storage device 703 may correspond to the storage unit 120 in FIG. 2.

The input unit 704 may correspond to the input unit 140 in FIG. 2.

The output unit 705 may correspond to the output unit 150 in FIG. 2.

The communication unit 706 may correspond to the communication unit 130 in FIG. 2.

As described above, the blocks serving as functional units of the load evaluation device 1 illustrated in FIG. 2 may be implemented by the computer 700 having the hardware configuration illustrated in FIG. 20. However, means for implementing the units included in the computer 700 are not limited to those described above. In other words, the computer 700 may be implemented by a single physically-integrated device, or may be implemented by two or more physically-separated devices that are connected to each other with wire or by wireless.

Instead, the recording medium 707 with the codes of the above-described programs recorded therein may be provided to the computer 700, and the CPU 701 may be configured to load and then execute the codes of the programs stored in the recording medium 707. Alternatively, the CPU 701 may be configured to store the codes of each program stored in the recording medium 707, in the storage unit 702, the storage device 703, or both. In other words, this exemplary embodiment includes an exemplary embodiment of the recording medium 707 for storing programs (software) to be executed by the computer 700 (CPU 701) in a transitory or non-transitory manner.

### <Description of Operation>

Next, the operation of the load evaluation device 1 according to the first exemplary embodiment will be described. FIG. 8 is a flowchart illustrating the operation of the load evaluation device 1.

First, the class acquiring unit 122 acquires data on classes necessary for creating a frequency distribution (S11). For example, the class acquiring unit 122 acquires class data related to request rates or request intervals as that presented in FIG. 5 as an example. In the following, description will be given by assuming that the class acquiring unit 122 receives class data related to request rates.

Then, the observed frequency distribution creating unit 123 acquires the class data related to request rates from the class acquiring unit 122. Subsequently, the observed frequency distribution creating unit 123 calculates request rates on the basis of the time series data stored in the time series data storing unit 111. Subsequently, the observed frequency distribution creating unit 123 aggregates the calculated request rates on the basis of the class data acquired from the class acquiring unit 122, and thereby creates observed frequency distribution data related to request rates (S12). Thus, the observed frequency distribution creating unit 123 creates observed frequency distribution data related to request rates as that presented in FIG. 6, for example.

Meanwhile, the expected frequency distribution acquiring unit 124 acquires or creates expected frequency distribution data, which is a frequency distribution expected when it is assumed that the distribution of observed values follows the distribution desired by the operator. For example, the expected frequency distribution acquiring unit 124 acquires or creates expected frequency distribution data as that presented in FIG. 7 (S13).

FIG. 9 presents again the observed frequency distribution and the expected distribution, which are however combined for simplicity this time.

Then, the superior level acquiring unit 125 acquires a significance level value from the operator. The superior level acquiring unit 125 acquires the value of a significance level, e.g., ‘5%’ (S14).

The goodness-of-fit testing unit 126 carries out goodness-of-fit testing for the observed frequency distribution data created by the observed frequency distribution creating unit 123 and the expected frequency distribution data acquired by the expected frequency distribution acquiring unit 124 (S15).

The goodness-of-fit testing unit 126 uses a chi-square test, which is well known in the field of Statistics, for goodness-of-fit testing. Goodness-of-fit testing using a chi-square test is a method of testing an assumption that the ‘observed distribution of frequents of events fits an expected frequent distribution’. For example, in the case having a significance level of 5%, the assumption is rejected when the chi-square value calculated on the basis of the difference between the observed events and the expected events falls within a risky range, which is smaller than 5%, leading to a conclusion that the distributions are highly unlikely to fit. On the other hand, when the chi-square value does not fall within the risky range, which is smaller than 5%, the assumption that the distributions fit is accepted, leading to a conclusion that the distributions are highly likely to fit.

In the following, a chi-square test will be described concretely. In a chi-square (χ2) test, first, a chi-square value is calculated on the basis of the distribution of observed frequencies and the distribution of expected frequencies. Assume that each observed frequency and each expected frequency in a class i are denoted by Oi and Ei, respectively. In this case, the chi-square value is calculated according to the following equation.

χ2=Σi((Oi−Ei)2/Ei)

In this example, the chi-square value is calculated as follows: {(15−13.5)2/13.5}+{(27−27.1)2/27.1}+{(29−27.1)2/27.1}+{(13−18.0)2/18.0}+{(6−9.02)2/9.02}+{(5−3.61)2/3.61}+{(5−1.66)2/1.66} nearly equal 9.96. Then, the probability of having a chi-square value of 9.96 is calculated on the basis of a chi-square distribution table. FIG. 4 presents part of a chi-square distribution table. The number of degrees of freedom in the chi-square distribution table corresponds to the value obtained by subtracting one from the number of classes. Specifically, the number of degrees of freedom in this example is: 7−1=6. This indicates that, when the frequencies in six classes are determined, the remaining expected frequency is automatically determined, since the number of pieces of sample data is fixed at 100. The chi-square distribution table in FIG. 4 presents the following respects concerning the chi-square value in the case of having number of degrees of freedom of 6.
The probability that the chi-square value is smaller than or equal to 0.872 or larger than or equal to 16.812 is smaller than or equal to 1%.
The probability that the chi-square value is smaller than or equal to 1.237 or larger than or equal to 14.449 is smaller than or equal to 2.5%.
The probability that the chi-square value is smaller than or equal to 1.635 or larger than or equal to 12.592 is smaller than or equal to 5%.

In this example, it is determined that the probability of having a calculated chi-square value of 9.69 is not within the risky range, which is smaller than 5%.

In other words, the above-described assumption that the ‘observed distribution of frequents of events fits an expected frequent distribution’ is accepted at a significance level of 5%. Hence, the observed data may be considered to fit the distribution intended by the user.

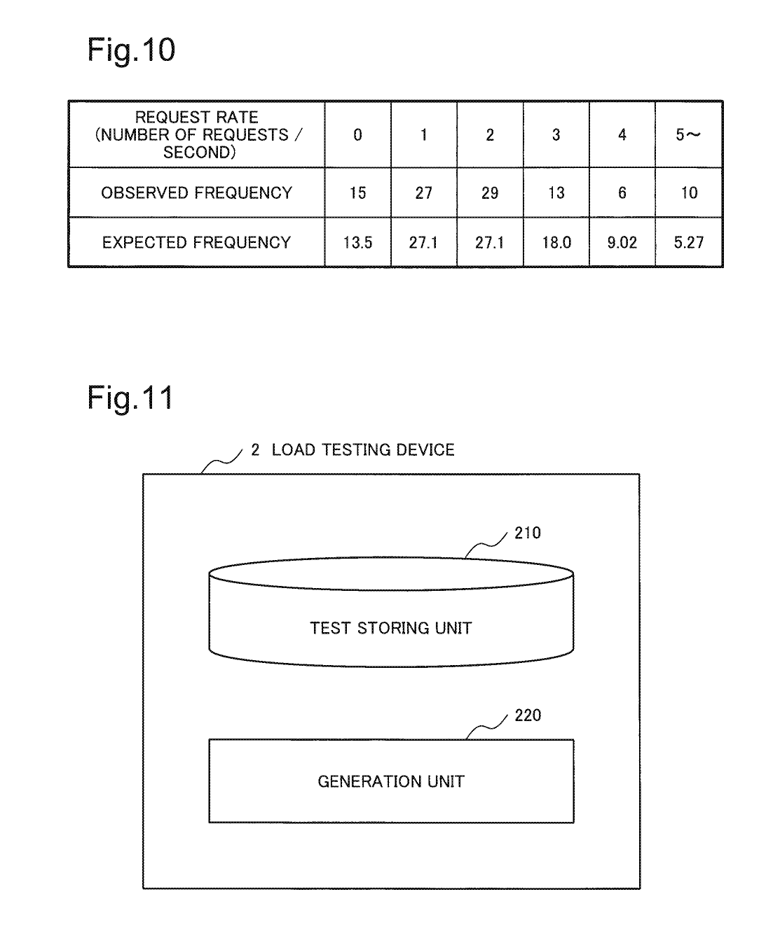

It is known that, when the expected frequencies are smaller than 10 or 5 in one or more classes, the margin of the error of the calculated chi-square value is likely to be large. In the case of this example, for calculation of a chi-square value, the classes for the request rates ‘5’ and ‘6-’ may be combined as ‘5-’ as presented in FIG. 10.

Lastly, the output unit 150 outputs the determination result indicating that the distributions fit, to an external output device such as a display, a log file, or the like (S16). In the case of the example described above, the determination result indicates that the request rates under the load generated by the load generation device follow the distribution intended by the user.

### Modified Example of First Exemplary Embodiment

In the above-described example, evaluation of the distribution related to the request rates of requests transmitted by the load testing device 2 is performed. However, it is also possible to perform evaluation of the distribution related to the intervals of requests transmitted by the load testing device 2. To perform evaluation related to request intervals, class data related to request intervals may be used as the class data acquired by the class acquiring unit 122, and a distribution following an exponential distribution may be used as the expected frequency distribution acquired or calculated by the expected frequency distribution acquiring unit 124.

An example of the class data related to request intervals is, for example, as follows.

Class 1: longer than or equal to 0.0 (second), and shorter than 0.1 (second)

Class 2: longer than or equal to 0.1 (second), and shorter than 0.2 (second)

Class 3: longer than or equal to 0.2 (second), and shorter than 0.3 (second)

Class 4: longer than or equal to 0.3 (second), and shorter than 0.4 (second)

Class 5: longer than or equal to 0.4 (second), and shorter than 0.5 (second)

Class 6: longer than or equal to 0.5 (second), and shorter than 0.6 (second)

Class 7: longer than or equal to 0.6 (second)

When the class data received by the class acquiring unit 122 is data related to request intervals, the observed frequency distribution creating unit 123 may create observed frequency distribution data related to request intervals. By contrast, when the class data received by the class acquiring unit 122 is data related to request rates, the observed frequency distribution creating unit 123 may create observed frequency distribution data related to request rates.

The load evaluation device 1 and the load testing device 2 may be an integrated device. The class acquiring unit 122 may acquire class data from an unillustrated storage unit or the like provided separately, instead of acquiring the data from the operator. The expected frequency distribution acquiring unit 124 may acquire expected frequency distribution data from an unillustrated storage unit or the like provided separately, instead of acquiring the data from the operator. The significance level acquiring unit 125 may acquire expected frequency distribution data from an unillustrated storage unit or the like provided separately, instead of acquiring the data from the operator.

As described above, the load evaluation device 1 according to this exemplary embodiment can test whether or not request transmission time intervals or request transmission rates used for transmission of requests by the load testing device 2 follow a predetermined distribution. The load evaluation device 1 can check whether or not load testing was carried out accurately, by referring to related information, and also determines whether or not the result of the load testing is reliable.

The reason is because the load evaluation device 1 includes the following configuration. Firstly, the time series data storing unit 111 stores time series data including request transmission time points of respective requests transmitted from the load testing device 2 to the test-target system 3. Secondly, the observed frequency distribution creating unit 123 calculates request rates each corresponding to the number of requests transmitted per unit time, on the basis of the time series data. Thirdly, the observed frequency distribution creating unit 123 aggregates the request rates on the basis of the class data indicating aggregation section widths for creating frequency distribution data, and then creates observed frequency distribution data related to request rated. Fourthly, the expected frequency distribution acquiring unit 124 acquires expected frequency distribution data, which is frequency distribution data expected when it is assumed that the distribution of request rates fits the desired probability distribution. Fifthly, the goodness-of-fit testing unit 126 carries out goodness-of-fit testing of the observed frequency distribution data with the desired probability distribution, by using the observed frequency distribution data and the expected frequency distribution data.

### Second Exemplary Embodiment

A load evaluation device 1 according to a second exemplary embodiment takes, as a target for evaluation, a load test of a type carried out on the basis of a test scenario.

First, the concept of a ‘test scenario’ in load testing will be described. A ‘test scenario’ is a script for applying a load to the test-target system 3 by transmitting requests to the test-target system 3. A test scenario is executed by ‘virtual users’. A ‘virtual user’ is a function for transmitting requests to the test-target system 3, and is generated by a load testing device 2. In the following, the configuration of the load testing device 2 that is a target for evaluation by the load evaluation device 1 according to the second exemplary embodiment will be described.

### <Configuration of Load Testing Device 2>

FIG. 11 is a block diagram illustrating the configuration of the load testing device 2 according to the second exemplary embodiment. The load testing device 2 is configured by including a test storing unit 210 and a generation unit 220.

The test storing unit 210 stores a test scenario.

The test scenario is a script for providing a load to the test-target system 3 by transmitting requests to the test-target system 3. The test scenario is assumed to include a process starting with transmission of a request and ending with reception of a response corresponding to the request, a multiple number of times. The concrete contexts of the test scenario are determined by the operator of the load testing device 2 in consideration of the typical processes performed by the test-target system 3.

For example, when the test-target system 3 is a Web server, the data of each request includes the URL (Uniform Resource Locator) of the Web server. For example, when the test-target system 3 is an online shopping site, a series of requests in a test scenario corresponds to a series of operations by each customer of the online shopping site as those to be described below. The operations are, for example, browsing a product, selecting a product, checking a shopping cart, and inputting a delivery address or a credit card number.

The generation unit 220 generates ‘virtual users’ and causes each of the virtual users to execute the test scenario.

A virtual user is a function for transmitting requests to the test-target system 3, in order to simulate accesses to the test-target system 3 by a user, for example. Each virtual user applies a load to the test-target system 3 by transmitting requests to the test-target system 3.

The generation unit 220 generates OS-level threads or processes so that the number of threads or processes would correspond to the number of virtual users, in order to allow the load testing device 2 to cause the multiple virtual users to operate in parallel, and causes each of the virtual users to execute the test scenario in a corresponding one of the threads or processes.

### <Typical Behavior of Virtual Users>

Next, typical behavior of virtual users will be described. There are two models of typical behavior of virtual users: the ‘closed model’ and the ‘open model’. The model to use as the typical behavior of virtual users is selected from the ‘closed model’ and the ‘open model’ by the operator of the load testing device 2 in consideration of the characteristics of load testing to be carried out.

### <Description of Closed Model>

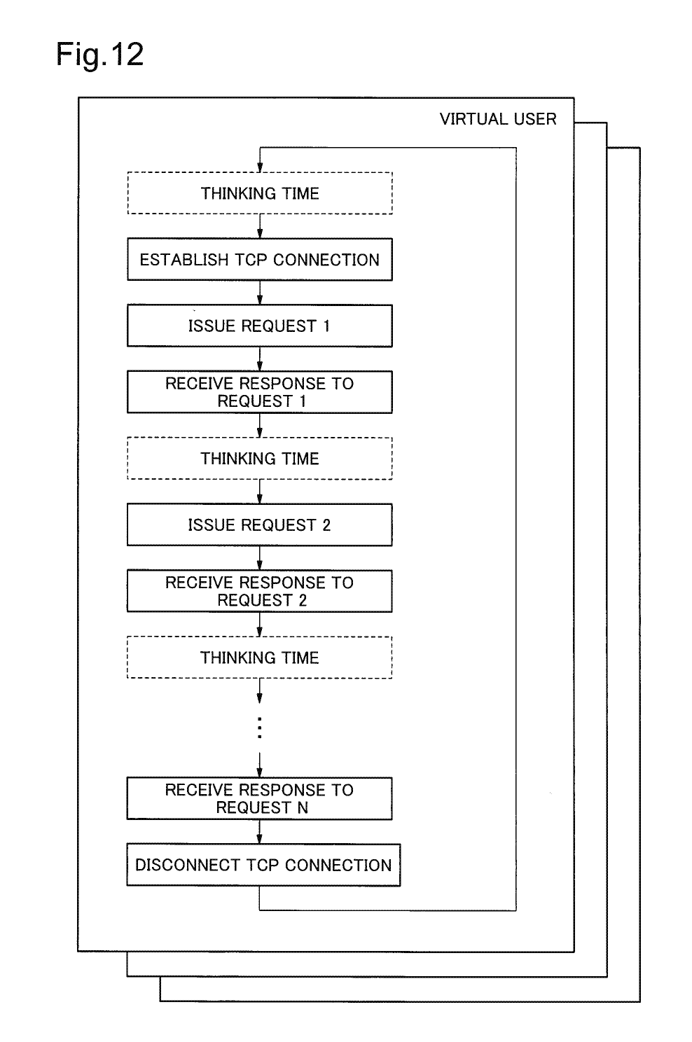

FIG. 12 is a flowchart illustrating the typical behavior of virtual users in the closed model.

Before transmitting requests to the test-target system 3, each virtual user first establishes TCP connection according to a TCP/IP (Transmission Control Protocol/Internet Protocol) protocol. Thereby, a logical channel for transmitting and receiving requests and responses is established between the load testing device 2, where the virtual user operates, and the test-target system 3.

After the establishment of the TCP connection, the virtual user transmits requests specified in the test scenario. First, the virtual user transmits the first request, and then receives a response to the first request. The virtual user becomes inactive for a certain period of time (thinking time) after receiving a response to a request until transmitting the next request. Upon the elapse of the thinking time after receiving the response to the first request, the virtual user transmits the second request, and then receives a response to the second request.

The virtual user repeats these operations, and disconnects the TCP connection upon receipt of a response to the N-th request, the number of requests (N) being specified in the test scenario. In the period from the establishment of the TCP connection to the disconnection of the TCP connection, the virtual user completes a process corresponding to that carried out by a single user. Then, after being inactive for the certain time period (thinking time) since the completion of receiving the response to the N-th request, the virtual user executes the test scenario again.

The virtual user repeatedly executes the test scenario a predetermined number of times or for a predetermined time period. This is because, if each virtual user terminates the process after executing the test scenario once, it is not possible to continuously applying a load to the test-target system 3 for a certain time period.

Such a configuration in which a fixed number of virtual users individually repeat a similar request process is called the closed model.

Thinking time is a time period simulating ‘time for selection of a request by a user’. For example, assume that the test-target system 3 is an online shopping site. A customer of the online shopping site receives a response (e.g., description of a product, an image of a product, a video of a product, or the like) to a request. Thereafter, the customer checks the displayed page of the product, considers which product to choose, or inputs a delivery address or a credit card number, for example. Upon the elapse of time for the above-described operation after receiving the response to the request, the customer transmits the next request. The time interval between reception of a response to a request to transmission of the next request by the user is simulated by using thinking time.

The length of each thinking time is based on a parameter that can be set by the operator of the load testing device 2. It is often the case that the operator of the load testing device 2 sets the parameter at the average value of the lengths of thinking times. Then, the load testing device 2 determines the lengths of respective thinking times, each corresponding to a time period until transmission of a request, on the basis of the parameter, by using random numbers following an exponential distribution. The load testing device 2 adjusts the time intervals for transmitting requests, in order to simulate variable request transmission intervals.

Now, assume that the time after transmission of a request until reception of a response to the request by a virtual user (response time) is denoted by RT, and a corresponding thinking time is denoted by TT. In this case, each request transmission time interval in the test scenario is determined on the basis of the sum of the response time RT and the thinking time TT. Here, the response time RT is an observed value affected by the state of the load applied to the test-target system 3, and cannot be directly controlled by the operator of the load testing device 2.

When the load applied to the test-target system 3 increases, thereby increasing the response time RT to be longer than the thinking time TT, the response time RT is dominant in each determined request transmission interval. Such being the case, the attempt made to simulate variable request transmission intervals using random numbers for the thinking times TT cannot bring about high effects. This causes the determined request transmission intervals to be different from request transmission intervals intended by the operator.

Moreover, the closed model has a problem that, when the load applied to the test-target system 3 increases, thereby increasing each response time, the time required for the completion of the test scenario also increases, which consequently delays the time for repeating the test scenario (virtual user arrival). In other words, the closed model has a disadvantage that the load generated by the load generation device decreases when the load applied to the test-target system 3 increases.

### <Description of Open Model>

The difference between the closed model and the open model is that each virtual user repeatedly executes a test scenario in the closed model while a virtual user is dynamically generated and is then deleted after execution of a test scenario in the open model.

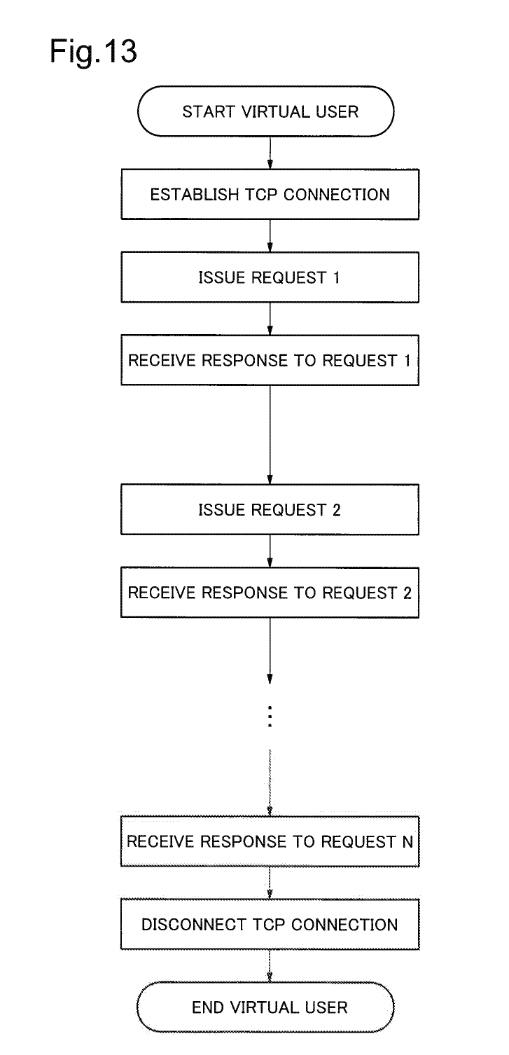

FIG. 13 is a flowchart illustrating typical behavior of virtual users in the open model.

Before transmitting requests to the test-target system 3, each virtual user first establishes a TCP connection according to a TCP/IP protocol. Thereby, a logical channel for transmitting and receiving requests and responses is established between the load testing device 2, where the virtual user operates, and the test-target system 3.

After the establishment of the TCP connection, the virtual user transmits requests specified in the test scenario. First, the virtual user transmits the first request, and then receives a response to the first request.

Then, the virtual user transmits the second request, and then receives a response to the second request. The virtual user repeats these operations, and disconnects the TCP connection upon receipt of a response to the N-th request, the number of requests (N) being specified in the test scenario. In the period from the establishment of the TCP connection to the disconnection of the TCP connection, the virtual user completes a process corresponding to that carried out by a single user.

In the open model, a virtual user arrives at the frequency intended by the user irrespective of the load applied to the test-target system 3. Hence, it is possible to generate a more accurate load than that generated in the closed model.

In the above, description has been given of an overview of load testing carried out on the basis of a test scenario, and the concept of a test scenario.

### <Description of Configuration>

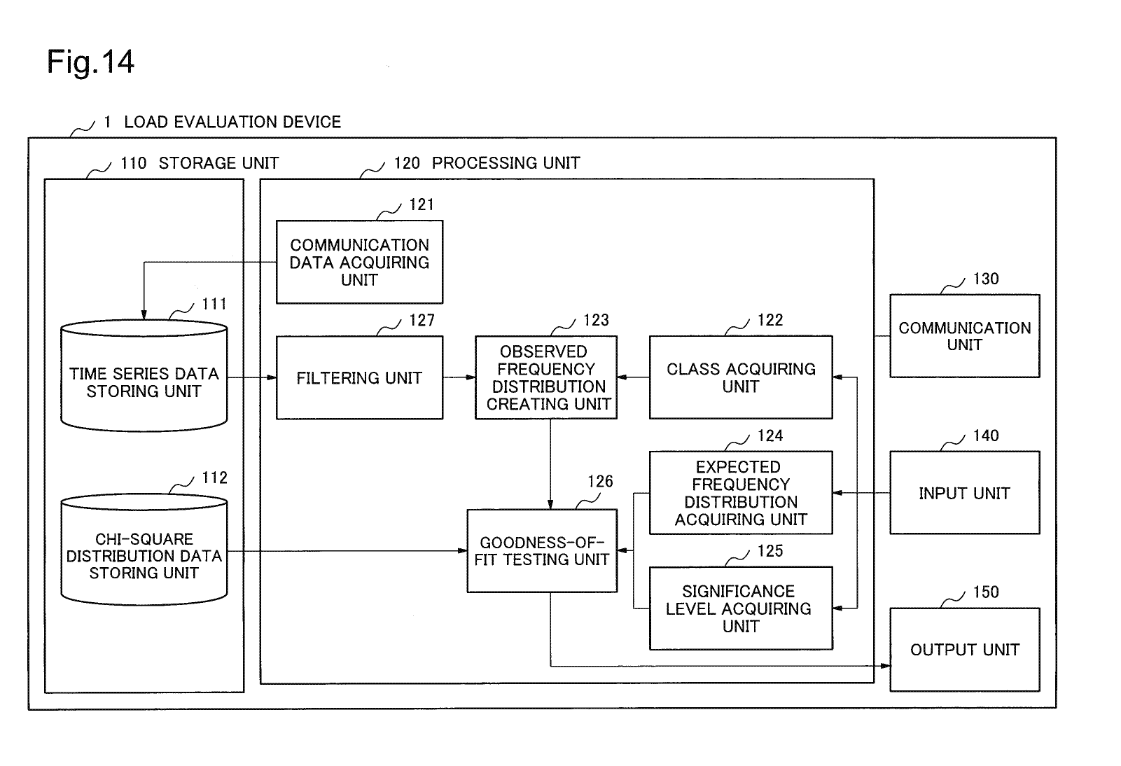

FIG. 14 is a block diagram illustrating the configuration of the load evaluation device 1 according to the second exemplary embodiment of the present invention. The same or similar constituent elements as those in the first exemplary embodiment are denoted by the same reference numerals, and description of those constituent elements is omitted. The load evaluation device 1 according to the second exemplary embodiment includes a filtering unit 127 in addition to the configuration of the load evaluation device 1 according to the first exemplary embodiment presented in FIG. 2.

The filtering unit 127 extracts data on each first request in a test scenario, from time series data stored in a time series data storing unit 111.

The time series data storing unit 111 stores time series data of request transmission time points of respective requests transmitted to the test-target system 3 by each virtual user by repeatedly executing a script. In addition, the time series data storing unit 111 also stores time series data of request transmission time points of respective TCP connection requests requested to the test-target system 3 by each virtual user at the time of starting execution of the script.

The filtering unit 127 extracts the data on the transmission time point of the initial request transmitted after a TCP connection request is transmitted to the test-target system 3 by the load testing device 2, from the time series data storing unit 111. This is because, as described above in the description of the closed model and the open model, the initial request transmitted after the TCP connection request is the first request in the test scenario.

The operation of the filtering unit 127 will be described by using a concrete example of the data stored by the time series data storing unit 111 presented in FIG. 3. FIG. 3 presents log information related to communications between the load testing device 2 and the test-target system 3.

Rows 10047 to 10049 in FIG. 3 indicate that a virtual user generated by the load testing device 2 has issued a connection establishment request to the test-target system 3 and the connection has been successfully established. Here, the virtual user corresponds to the port identified by the number 1855 of the address 192.168.0.1. Moreover, the test-target system 3 corresponds to the port identified by the number 80 of the address 192.168.0.2. Each application in the OS performs communications via the TCP ports. As preparation for the communications, the application in the OS establishes connection between the ports by transmitting and receiving [SYN], [SYN, ACK], and [ACK] packets.

A row 10050 in FIG. 3 indicates that a GET request has been transmitted for the contents corresponding to /some.php on the server, from the virtual user to the test-target system 3 by using a HTTP protocol. Since the request recorded in the row 10050 is the initial request transmitted after the TCP connection request recorded in the rows 10047 to 10049, the filtering unit 127 extracts the data on the transmission time point of the request recorded in the row 10050.

In this way, the filtering unit 127 analyzes the data stored by the time series data storing unit 111, and extracts data on the each request in the test scenario.

### <Description of Operation>

Next, the operation of the load evaluation device 1 according to the second exemplary embodiment will be described. FIG. 15 is a flowchart illustrating the operation of the load evaluation device 1.

First, the filtering unit 127 extracts data on each first request in the test scenario, from the time series data stored in the time series data storing unit 111. Subsequently, the filtering unit 127 outputs the extracted data to the observed frequency distribution creating unit 123 (S21).

Then, the class acquiring unit 122 acquires class data necessary for creating a frequency distribution (S11).

Thereafter, the observed frequency distribution creating unit 123 analyzes request rates related to each first request in the test scenario, on the basis of the data outputted by the filtering unit 127. The observed frequency distribution creating unit 123 also creates observed frequency distribution data related to the request rates, on the basis of the class data acquired from the class acquiring unit 122 (S12).

The operations subsequent to the above are the same as those of a load evaluation device 1 according to the first exemplary embodiment, and hence description thereof is omitted.

The load evaluation device 1 according to the second exemplary embodiment evaluates request intervals or request rates that are only related to each first request in the test scenario. When the request intervals follow an exponential distribution, approximate evaluation can be made for all the requests transmitted by the load testing device 2, only by making evaluation of each first request in the test scenario. Similarly, when the request intervals follow a Poisson distribution, approximate evaluation can be made for all the requests transmitted by the load testing device 2, only by making evaluation of each first request in the test scenario. Such approximate evaluations are possible due to the ‘memoryless property’ of an exponential distribution and a Poisson distribution.

As has been described above, in the load evaluation device 1 according to the second exemplary embodiment, the filtering unit 127 extracts only part of the time series data stored in the time series data storing unit 111. Then, the observed frequency distribution creating unit 123 performs aggregation on the data extracted by the filtering unit 127 only. For this reason, in the load evaluation device 1 according to the second exemplary embodiment, the amount of data to be a target of aggregation by the observed frequency distribution creating unit 123 is small. Hence, it is possible to implement a series of operations by the observed frequency distribution creating unit 123 at a low cost.

Moreover, the load evaluation device 1 according to the second exemplary embodiment evaluates request intervals or request rates only in relation to each first request in the test scenario extracted by the filtering unit 127. This enables the load evaluation device 1 to evaluate virtual user arrival intervals or rates. In the open model, the virtual-user arrival intervals or rates are controlled by the load testing device 2 without any influence of the load applied to the test target system 3, as described above. Accordingly, the load evaluation device 1 according to the second exemplary embodiment can accurately evaluate the quality of the requests (request intervals or request rates) by evaluating the virtual-user arrival intervals or rates, without being affected by the load applied to the test-target system 3. Here, the requests correspond to the requests transmitted by each virtual user generated by the load testing device 2.

### Modified Example of Second Exemplary Embodiment

Note that data that the data extracted by the filtering unit 127 from the time series data storing unit 111 does not need to be only the data on each first request in the test scenario. For example, the filtering unit 127 may extract each TCP connection request to the test-target system 3 from the load testing device 2.

Requests to a Web server are normally transmitted using a protocol such as HTTP or HTTPS (Hypertext Transfer Protocol over Secure Socket Layer). HTTP and HTTPS are protocols operating at a TCP protocol, and it requires less to analyze TCP communication packets than HTTP or HTTPS packets.

Hence, goodness-of-fit testing for a TCP connection requests can be performed at an even lower cost than that of goodness-of-fit testing for the first requests in the test scenario.

The filtering unit 127 extracts data on the TCP-connection-request transmission time points from the time series data storing unit 111, and then outputs the data to the observed frequency distribution creating unit 123.

The observed frequency distribution creating unit 123 calculates the numbers of times TCP connection is requested per unit time (TCP connection request rates) on the basis of the data extracted by the filtering unit 127. Then, the observed frequency distribution creating unit 123 aggregates the calculated TCP connection request rates on the basis of class data acquired from the class acquiring unit 122, and thereby creates observed frequency distribution data related to the TCP connection request rates.

The subsequent operations are the same as those of the load evaluation device 1 according to the first exemplary embodiment, and hence description thereof is omitted.

### Third Exemplary Embodiment

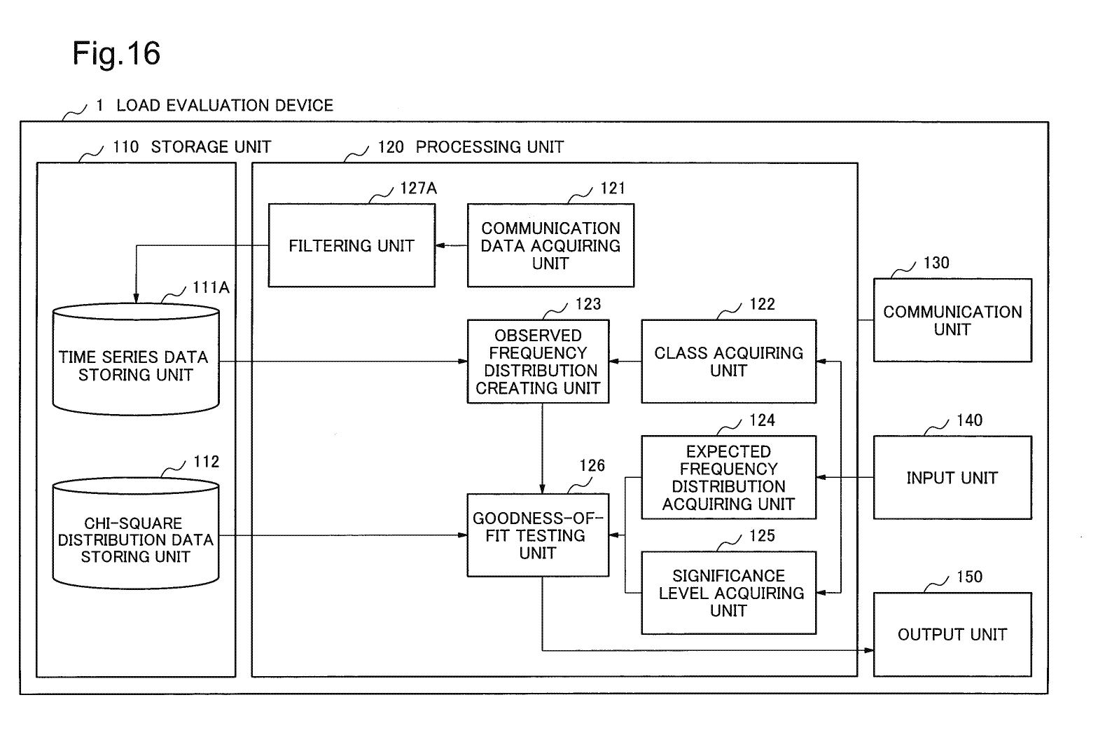

FIG. 16 is a block diagram illustrating a configuration of a load evaluation device 1 according to the third exemplary embodiment of the present invention. The same or similar constituent elements as those in the first exemplary embodiment are denoted by the same reference numerals, and description thereof is omitted.

The load evaluation device 1 according to the third exemplary embodiment includes a filtering unit 127A instead of the filtering unit 127 of the configuration of the load evaluation device 1 of the second exemplary embodiment illustrated in FIG. 14. In addition, the load evaluation device 1 according to the third exemplary embodiment includes a time series data storing unit 111A instead of the time series data storing unit 111.

The load evaluation device 1 according to the third exemplary embodiment can use less amount of storage of the time series data storing unit 111A, than that used by the load evaluation device 1 according to the first exemplary embodiment.

This is because, in the load evaluation device 1 according to the third exemplary embodiment, only part of the data related to communications acquired by the communication data acquiring unit 121 is extracted by the filtering unit 127A, and is stored in the time series data storing unit 111A. Specifically, the filtering unit 127A extracts data on the time point of the transmission of each first request in the test scenario or data on the time point of transmission of each TCP connection request, from the data related to communications acquired by the communication data acquiring unit 121, and the extracted data is stored in the time series data storing unit 111.

The operation of the filtering unit 127A for extracting data on each first request in the test scenario or TCP connection request is the same as that in the second exemplary embodiment, and hence description thereof is omitted. Moreover, the operation of the load evaluation device 1 according to the third exemplary embodiment for carrying out goodness-of-fit testing of the distribution of request intervals or request rates is the same as that in the first exemplary embodiment, and hence description thereof is omitted.

As has been described above, in the load evaluation device 1 according to the third exemplary embodiment, the time series data storing unit 111A stores only part of data extracted by the filtering unit 127. In this way, the load evaluation device 1 according to the third exemplary embodiment can use less amount of storage of the time series data storing unit 111A.

### Fourth Exemplary Embodiment

A load evaluation device 1 according to the fourth exemplary embodiment of the present invention will be described in detail with reference to a drawing.

FIG. 19 is a diagram illustrating the configuration of the load evaluation device 1 according to the fourth exemplary embodiment.

The load evaluation device 1 according to the fourth exemplary embodiment includes the time series data storing unit 111, the observed frequency distribution creating unit 123, the expected frequency distribution acquiring unit 124, and the goodness-of-fit testing unit 126.

The time series data storing unit 111 stores time series data of transmission time points of respective requests transmitted from the load generation device to the test-target system 3.

The observed frequency distribution creating unit 123 calculates request rates on the basis of the stored time series data, aggregates the request rates on the basis of class data, and creates frequency distribution data related to the request rates. Each of the request rates is the number of requests transmitted per unit time. The class data includes aggregation section widths for creating frequency distribution data.

The expected frequency distribution acquiring unit 124 acquires expected frequency distribution data, which is frequency distribution data expected when it is assumed that the distribution of the request rates fits desired probability distribution.

The goodness-of-fit testing unit 126 carries out goodness-of-fit testing of the observed frequency distribution data with the desired probability distribution by using the observed frequency distribution data and the expected frequency distribution data.

With the above-described configuration, the load evaluation device 1 of this exemplary embodiment can evaluate whether the load testing device 2 is generating a desired load to the test-target system. Here, ‘whether the load testing device is generating a desired load to the test-target system’ includes ‘whether the requests transmitted by the load testing device follow a predetermined distribution’.

In the invention of this application, the load testing device 2 is an example of the ‘load generation device’ described in the scope of claims. Alternatively, each virtual user generated by the load testing device may be considered as the ‘load generation device’ described in the scope of claims. The load testing device 2 may be configured so that an agent including only the request transmitting/receiving function would be provided separately from the load testing device 2. In this case, the agent, which communicates with the test-target system 3 for transmission and reception of requests, corresponds to the ‘load generation device’ described in the scope of claims.

The whole or part of the exemplary embodiments disclosed above can be described as, but not limited to, the following supplementary notes.

(Supplementary note 1) An information processing device comprising:

a time series data storing unit which stores time series data including a transmission time point of each request transmitted from a load generation device to a test-target system;

an observed frequency distribution creating unit which calculates a request rate, which is the number of requests transmitted per unit time, by using said time series data, aggregating said request rates with reference to class data, which indicates aggregation section widths for creating frequency distribution data, and creating frequency distribution data of said request rates;

an expected frequency distribution acquiring unit which acquires expected frequency distribution data, which is frequency distribution data expected when it is assumed that a distribution of said request rates follows a desired probability distribution; and

a goodness-of-fit testing unit which carries out goodness-of-fit testing of said observed frequency distribution data with said desired probability distribution by using said observed frequency distribution data and said expected frequency distribution data.

(Supplementary note 2) The information processing device according to supplementary note 1, wherein

said time series data stored by said time series data storing unit is time series data including a transmission time point of each request transmitted to said test-target system by repeatedly executing by said load generation device a script including a plurality of times a process of transmitting a request and receiving a response to said request,

the information processing device further comprises a filtering unit which extracts data on a transmission time point of each of first requests in said script, and outputting said extracted data to said observed frequency distribution creating unit,

said observed frequency distribution creating unit calculates a request rate, which is the number of said first requests transmitted per unit time, by using said data extracted by said filtering unit, aggregates said request rates, and creates observed frequency distribution data, and

said expected frequency distribution acquiring unit acquires expected frequency distribution data, which is frequency distribution data expected when it is assumed that a distribution of said request rates follows a desired probability distribution.

(Supplementary note 3) The information processing device according to supplementary note 1, wherein said time series data storing unit includes time series data including a transmission time point of each request transmitted to said test-target system by repeatedly executing by said load generation device a script including a plurality of times a process of transmitting a request and receiving a response to said request, and time series data including a transmission time point of each TCP connection request requested to said test-target system at time of starting execution of said script by said load generation device,

the information processing device further comprises a filtering unit which extracts data on said transmission time point of each of TCP connection requests to said test-target system from said load generation device, and outputting said extracted data to said observed frequency distribution creating unit,

said observed frequency distribution creating unit calculates TCP connection request rates, each of which is the number of said TCP connection requests transmitted per unit time, by using said data extracted by said filtering unit, aggregates said TCP connection request rates, and creates observed frequency distribution data, and

said expected frequency distribution acquiring unit acquires expected frequency distribution data, which is frequency distribution data expected when it is assumed that a distribution of said TCP connection request rates follows a desired probability distribution.

(Supplementary note 4) An information processing device comprising:

a time series data storing unit which stores time series data including a transmission time point of each request transmitted from a load generation device to a test-target system;

an observed frequency distribution creating unit which calculates request transmission time intervals by using said time series data, aggregating said request transmission time intervals with reference to class data, which indicates aggregation section widths for creating frequency distribution data, and creating frequency distribution data of said request transmission time intervals;

an expected frequency distribution acquiring unit which acquires expected frequency distribution data, which is frequency distribution data expected when it is assumed that a distribution of said request transmission time intervals follows a desired probability distribution; and

a goodness-of-fit testing unit which carries out goodness-of-fit testing of said observed frequency distribution data with said desired probability distribution by using said observed frequency distribution data and said expected frequency distribution data.

(Supplementary note 5) The information processing device according to supplementary note 4, wherein

said time series data stored by said time series data storing unit is time series data including a transmission time point of each request transmitted to said test-target system by repeatedly executing by said load generation device a script including a plurality of times a process of transmitting a request and receiving a response to said request,

the information processing device further comprises a filtering unit which extracts data on a transmission time point of each of first requests in said script, and outputting said extracted data to said observed frequency distribution creating unit,

said observed frequency distribution creating unit calculates transmission time intervals of said first requests by using said data extracted by said filtering unit, aggregates said transmission time intervals of said first requests, and creates observed frequency distribution data, and

said expected frequency distribution acquiring unit acquires expected frequency distribution data, which is frequency distribution data expected when it is assumed that a distribution of said transmission time intervals of said first requests follows a desired probability distribution.

(Supplementary note 6) he information processing device according to supplementary note 4, wherein

said time series data storing unit includes time series data including a transmission time point of each request transmitted to said test-target system by repeatedly executing by said load generation device a script including a plurality of times a process of transmitting a request and receiving a response to said request, and time series data including a transmission time point of each TCP connection request requested to said test-target system at time of starting execution of said script by said load generation device,

the information processing device further comprises a filtering unit which extracts data on said transmission time point of each TCP connection request to said test-target system from said load generation device, and outputting said extracted data to said observed frequency distribution creating unit,

said observed frequency distribution creating unit calculates TCP connection request time intervals by using said data extracted by said filtering unit, aggregates said TCP connection request time intervals, and creates observed frequency distribution data, and

said expected frequency distribution acquiring unit acquires expected frequency distribution data, which is frequency distribution data expected when it is assumed that a distribution of said TCP connection request time intervals follows a desired probability distribution.

(Supplementary note 7) The information processing device according to any one of supplementary notes 1 to 6, comprising a class acquiring unit which acquires said class data.

(Supplementary note 8) An information processing system comprising:

an information processing device and a load generation device, wherein

the information processing device comprising:

a time series data storing unit which stores time series data including a transmission time point of each request transmitted from the load generation device to a test-target system;

an observed frequency distribution creating unit which calculates a request rate, which is the number of requests transmitted per unit time, by using said time series data, aggregating said request rates with reference to class data, which indicates aggregation section widths for creating frequency distribution data, and creating frequency distribution data of said request rates;

an expected frequency distribution acquiring unit which acquires expected frequency distribution data, which is frequency distribution data expected when it is assumed that a distribution of said request rates follows a desired probability distribution; and

a goodness-of-fit testing unit which carries out goodness-of-fit testing of said observed frequency distribution data with said desired probability distribution by using said observed frequency distribution data and said expected frequency distribution data.

(Supplementary note 9) An information processing system comprising:

the information processing device according to supplementary note 4; and

a load generation device, wherein

the information processing device comprising:

a time series data storing unit which stores time series data including a transmission time point of each request transmitted from the load generation device to a test-target system;

an observed frequency distribution creating unit which calculates request transmission time intervals by using said time series data, aggregating said request transmission time intervals with reference to class data, which indicates aggregation section widths for creating frequency distribution data, and creating frequency distribution data of said request transmission time intervals;

an expected frequency distribution acquiring unit which acquires expected frequency distribution data, which is frequency distribution data expected when it is assumed that a distribution of said request transmission time intervals follows a desired probability distribution; and

a goodness-of-fit testing unit which carries out goodness-of-fit testing of said observed frequency distribution data with said desired probability distribution by using said observed frequency distribution data and said expected frequency distribution data.

(Supplementary note 10) A method of controlling a device including a time series data storing means for storing time series data including a transmission time point of each request transmitted from a load generation device to a test-target system, the method controlling the device to perform:

a step of calculating request rates, each of which is the number of requests transmitted per unit time, by using said time series data, aggregating said request rates with reference to class data, which indicates aggregation section widths for creating frequency distribution data, and creating frequency distribution data of said request rates;

a step of acquiring expected frequency distribution data, which is frequency distribution data expected when it is assumed that a distribution of said request rates follows a desired probability distribution; and

a step of carrying out goodness-of-fit testing of said observed frequency distribution data with said desired probability distribution.

(Supplementary note 11) A non-transitory computer-readable recording medium recording a program for causing a computer including a time series data storing means for storing time series data including a transmission time point of each request transmitted from a load generation device to a test-target system, to execute:

an observed frequency distribution creating process for calculating request rates, which is number of requests transmitted per unit time, by using said time series data, aggregating said request rates with reference to class data, which indicates aggregation section widths for creating frequency distribution data, and creating frequency distribution data of said request rates;

an expected frequency distribution acquiring process for acquiring expected frequency distribution data, which is frequency distribution data expected when it is assumed that a distribution of said request rates follows a desired probability distribution; and

a goodness-of-hit testing process for carrying out goodness-of-fit testing of said observed frequency distribution data with said desired probability distribution.

The exemplary embodiments for implementing the invention of this application have been described above. It is to be noted that the above-described exemplary embodiments are set forth to better facilitate the understanding of the invention of this application, and is not intended to limit the interpretation of the invention of this application. Modifications and improvements can be made to the invention of this application without departing from the scope of the invention, and the equivalents of the invention are also included in the invention.

### INDUSTRIAL APPLICABILITY

The present invention is suitable for an evaluation device or system for a load testing device that checks performance or behavior of a server under application of a predetermined load.

### REFERENCE SIGNS LIST

1 Load evaluation device
2 Load testing device
3 Test-target system
4 Network
110 Storage unit
111 Time series data storing unit
112 Chi-square distribution data storing unit
120 Processing unit
121 Communication data acquiring unit
122 Class acquiring unit
123 Observed frequency distribution creating unit
124 Expected frequency distribution acquiring unit
125 Superior level acquiring unit
126 Goodness-of-fit testing unit
127 Filtering unit
130 Communication unit
140 Input unit
150 Output unit
160 Test storing unit
220 Generation unit

What is claimed is:

1-10. (canceled)

11. An information processing device comprising:
a time series data storing unit which stores time series data including a transmission time point of each request transmitted from a load generation device to a test-target system;
an observed frequency distribution creating unit which calculates a request rate, which is the number of requests transmitted per unit time, by using said time series data, aggregating said request rates with reference to class data, which indicates aggregation section widths for creating frequency distribution data, and creating frequency distribution data of said request rates;
an expected frequency distribution acquiring unit which acquires expected frequency distribution data, which is frequency distribution data expected when it is assumed that a distribution of said request rates follows a desired probability distribution; and
a goodness-of-fit testing unit which carries out goodness-of-fit testing of said observed frequency distribution data with said desired probability distribution by using said observed frequency distribution data and said expected frequency distribution data.

12. The information processing device according to claim 11, wherein
said time series data stored by said time series data storing unit is time series data including a transmission time point of each request transmitted to said test-target system by repeatedly executing by said load generation device a script including a plurality of times a process of transmitting a request and receiving a response to said request,
the information processing device further comprises a filtering unit which extracts data on a transmission time point of each of first requests in said script, and outputting said extracted data to said observed frequency distribution creating unit,
said observed frequency distribution creating unit calculates a request rate, which is the number of said first requests transmitted per unit time, by using said data extracted by said filtering unit, aggregates said request rates, and creates observed frequency distribution data, and
said expected frequency distribution acquiring unit acquires expected frequency distribution data, which is frequency distribution data expected when it is assumed that a distribution of said request rates follows a desired probability distribution.

13. The information processing device according to claim 11, wherein said time series data storing unit includes time series data including a transmission time point of each request transmitted to said test-target system by repeatedly executing by said load generation device a script including a plurality of times a process of transmitting a request and receiving a response to said request, and time series data including a transmission time point of each TCP connection request requested to said test-target system at time of starting execution of said script by said load generation device,
the information processing device further comprises a filtering unit which extracts data on said transmission time point of each of TCP connection requests to said test-target system from said load generation device, and outputting said extracted data to said observed frequency distribution creating unit,
said observed frequency distribution creating unit calculates TCP connection request rates, each of which is the number of said TCP connection requests transmitted per unit time, by using said data extracted by said filtering unit, aggregates said TCP connection request rates, and creates observed frequency distribution data, and
said expected frequency distribution acquiring unit acquires expected frequency distribution data, which is frequency distribution data expected when it is assumed that a distribution of said TCP connection request rates follows a desired probability distribution.

14. An information processing device comprising:
a time series data storing unit which stores time series data including a transmission time point of each request transmitted from a load generation device to a test-target system;
an observed frequency distribution creating unit which calculates request transmission time intervals by using said time series data, aggregating said request transmission time intervals with reference to class data, which indicates aggregation section widths for creating frequency distribution data, and creating frequency distribution data of said request transmission time intervals;
an expected frequency distribution acquiring unit which acquires expected frequency distribution data, which is frequency distribution data expected when it is assumed that a distribution of said request transmission time intervals follows a desired probability distribution; and
a goodness-of-fit testing unit which carries out goodness-of-fit testing of said observed frequency distribution data with said desired probability distribution by using said observed frequency distribution data and said expected frequency distribution data.

15. The information processing device according to claim 14, wherein
said time series data stored by said time series data storing unit is time series data including a transmission time point of each request transmitted to said test-target system by repeatedly executing by said load generation device a script including a plurality of times a process of transmitting a request and receiving a response to said request,
the information processing device further comprises a filtering unit which extracts data on a transmission time point of each of first requests in said script, and outputting said extracted data to said observed frequency distribution creating unit,
said observed frequency distribution creating unit calculates transmission time intervals of said first requests by using said data extracted by said filtering unit, aggregates said transmission time intervals of said first requests, and creates observed frequency distribution data, and
said expected frequency distribution acquiring unit acquires expected frequency distribution data, which is frequency distribution data expected when it is assumed that a distribution of said transmission time intervals of said first requests follows a desired probability distribution.

16. The information processing device according to claim 14, wherein
said time series data storing unit includes time series data including a transmission time point of each request transmitted to said test-target system by repeatedly executing by said load generation device a script including a plurality of times a process of transmitting a request and receiving a response to said request, and time series data including a transmission time point of each TCP connection request requested to said test-target system at time of starting execution of said script by said load generation device,
the information processing device further comprises a filtering unit which extracts data on said transmission time point of each TCP connection request to said test-target system from said load generation device, and outputting said extracted data to said observed frequency distribution creating unit,
said observed frequency distribution creating unit calculates TCP connection request time intervals by using said data extracted by said filtering unit, aggregates said TCP connection request time intervals, and creates observed frequency distribution data, and
said expected frequency distribution acquiring unit acquires expected frequency distribution data, which is frequency distribution data expected when it is assumed that a distribution of said TCP connection request time intervals follows a desired probability distribution.

17. The information processing device according to claim 11, comprising a class acquiring unit which acquires said class data.

18. The information processing device according to claim 12, comprising a class acquiring unit which acquires said class data.

19. The information processing device according to claim 13, comprising a class acquiring unit which acquires said class data.

20. The information processing device according to claim 14, comprising a class acquiring unit which acquires said class data.

21. The information processing device according to claim 15, comprising a class acquiring unit which acquires said class data.

22. The information processing device according to claim 16, comprising a class acquiring unit which acquires said class data.

23. An information processing system comprising:
an information processing device and a load generation device, wherein
the information processing device comprising:
a time series data storing unit which stores time series data including a transmission time point of each request transmitted from the load generation device to a test-target system;
an observed frequency distribution creating unit which calculates a request rate, which is the number of requests transmitted per unit time, by using said time series data, aggregating said request rates with reference to class data, which indicates aggregation section widths for creating frequency distribution data, and creating frequency distribution data of said request rates;
an expected frequency distribution acquiring unit which acquires expected frequency distribution data, which is frequency distribution data expected when it is assumed that a distribution of said request rates follows a desired probability distribution; and
a goodness-of-fit testing unit which carries out goodness-of-fit testing of said observed frequency distribution data with said desired probability distribution by using said observed frequency distribution data and said expected frequency distribution data.
